(19) United States
(12) Patent Application Publication
(10) Pub. No.: US 2013/0104377 A1
(43) Pub. Date: May 2, 2013

(54) Memento Methods

(71) Applicant: Melissa Koch, Orlando, FL (US)

(72) Inventor: Melissa Koch, Orlando, FL (US)

(21) Appl. No.: 13/247,993

(22) Filed: Sep. 28, 2011

(51) Int. Cl. B23P 11/00

(52) U.S. Cl. 29/525.08; 29/525.01

(57) ABSTRACT

A method to help, encourage, inspire, remind, reward, focus or otherwise inform a user may include positioning a user selected memento or a memento selected by a third party to have special meaning to a user onto a portable personal item so the user can readily experience the memento without handling the memento. The method may also include connecting the memento to the portable personal item with a fastener carried by a side of the memento where the connection may or may not penetrate the portable personal item.

### BACKGROUND

The invention relates to the field of mementos.

### SUMMARY

According to one embodiment of the invention, a method to help, encourage, inspire, remind, reward, focus or otherwise inform a user may include positioning a user selected memento or a memento selected by a third party to have special meaning to a user onto a portable personal item so the user can readily experience the memento without handling the memento. The method may also include connecting the memento to the portable personal item with a fastener carried by a side of the memento where the connection does not penetrate the portable personal item.

The method may further comprise including a picture, a design, a word, a logo, a stone, other natural or synthetic material, a symbol, a photograph, an aromatherapeutic, an oil, a balm, and/or a sentimental item as a portion of the memento. The method may additionally include securing the picture, photograph, design, word, logo, stone, other natural or synthetic material, and/or symbol onto the memento.

The method may also include using a magnet, or magnets, to connect the memento to the portable personal item and/or using a clip to connect the memento to the portable personal item and/or a pin and fastener to connect the memento to the personal item and/or an alternative method of fastening. The portable personal item may include a yoga mat, a towel, a blanket, a bag, a ribbon, a holder for such memento(s), and/or clothing.

The method may further include carrying portions of the memento on the outside of the memento and/or the inside of the memento. The method may additionally include providing the memento with an enclosed cavity to carry a portion of the memento.

The method may also include enabling the user to access the enclosed cavity. The memento may have a specific meaning to the user, which may be known or unknown to any person other than the user.

Another aspect of the invention is a method to help, encourage, inspire, remind, reward, focus or otherwise inform a user of a particular experience or sentiment that may include positioning a user selected memento or a memento selected by a third party to have special meaning to a user where the memento has a specific meaning to the user that may be known or unknown to any person other than the user onto a portable personal item so the user can readily experience the memento without handling the memento. The method may also include connecting the memento to the portable personal item with a fastener carried by a side of the memento where the connection does not penetrate the portable personal item using at least one of a magnet or magnets to connect the memento to the portable personal item and/or using a clip to connect the memento to the portable personal item and/or a pin and fastener to connect the memento to the personal item and/or an alternative method of fastening.

The method may further comprise including a picture, a design, a word, a logo, a stone or other natural or synthetic material, a symbol, an aromatherapeutic, an oil, a balm, and/or a sentimental item as a portion of the memento. The method may additionally include securing the picture, photograph, design, word, logo, stone or other natural or synthetic material, and/or symbol onto the memento.

The portable personal item may include a yoga mat, a towel, a blanket, a bag, a ribbon, a holder for such memento(s), and/or clothing. The method may also include carrying portions of the memento on the outside of the memento and/or the inside of the memento.

The method may further include providing the memento with an enclosed cavity to carry a portion of the memento. The method may additionally include enabling the user to access the enclosed cavity.

Another aspect of the invention is a method to help, encourage, inspire, remind, reward, focus or otherwise inform a user that may include positioning a user selected memento or a memento selected by a third party to have special meaning to a user where the memento has a specific meaning to the user that may be known or unknown to any person other than the user onto a portable personal item so the user can readily experience the memento without handling the memento. The method may also include connecting the memento to the portable personal item with a fastener carried by a side of the memento where the connection does not penetrate the portable personal item. The method may further comprise including a picture, a design, a word, a logo, a stone or other natural or synthetic material, a symbol, an aromatherapeutic, an oil, a balm, and/or a sentimental item as a portion of the memento. The method may additionally include carrying portions of the memento on the outside of the memento and/or the inside of the memento.

The method may also include securing the picture, photograph, design, word, logo, stone or other natural or synthetic material, and/or symbol onto the memento. The method may further include using a magnet or magnets to connect the memento to the portable personal item and/or using a clip to connect the memento to the portable personal item and/or a pin and fastener to connect the memento to the personal item and/or an alternative method of fastening. The method may additionally include providing the memento with an enclosed cavity to carry a portion of the memento where the user can access the enclosed cavity.

### BRIEF DESCRIPTION OF THE DRAWINGS

FIG. 1 is a flowchart illustrating method aspects according to the invention.

FIG. 2 is a flowchart illustrating method aspects according to the method of FIG. 1.

FIG. 3 is a flowchart illustrating method aspects according to the method of FIG. 1.

FIG. 4 is a flowchart illustrating method aspects according to the method of FIG. 1.

FIG. 5 is a flowchart illustrating method aspects according to the method of FIG. 2.

FIG. 6 is a flowchart illustrating method aspects according to the method of FIG. 5.

FIG. 7 is a flowchart illustrating method aspects according to the method of FIG. 6.

FIG. 8 is a flowchart illustrating alternative method aspects according to the invention.

FIG. 9 is a flowchart illustrating method aspects according to the method of FIG. 8.

FIG. 10 is a flowchart illustrating method aspects according to the method of FIG. 8.

FIG. 11 is a flowchart illustrating method aspects according to the method of FIG. 9.

FIG. 12 is a flowchart illustrating method aspects according to the method of FIG. 9.

FIG. 13 is a flowchart illustrating method aspects according to the method of FIG. 12.

FIG. 14 is a flowchart illustrating alternative method aspects according to the invention.

FIG. 15 is a flowchart illustrating method aspects according to the method of FIG. 14.

FIG. 16 is a flowchart illustrating method aspects according to the method of FIG. 14.

FIG. 17 is a flowchart illustrating method aspects according to the method of FIG. 14.

### DETAILED DESCRIPTION

The invention will now be described more fully hereinafter with reference to the accompanying drawings, in which preferred embodiments of the invention are shown. Like numbers refer to like elements throughout.

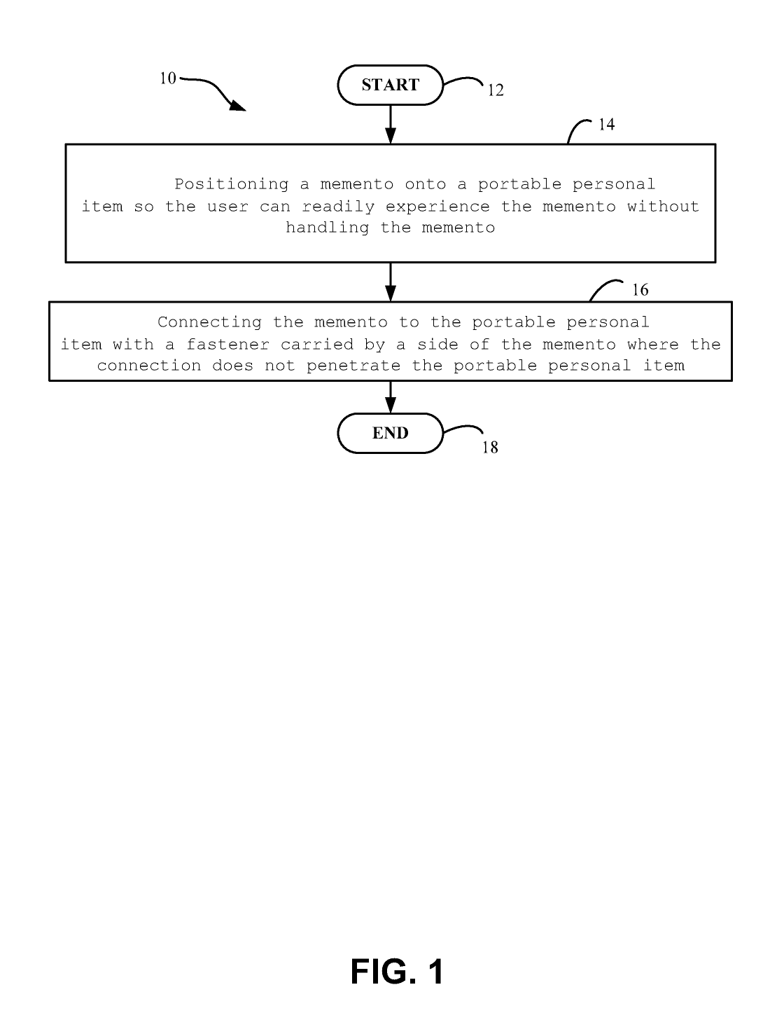

With reference now to FIG. 1, according to one embodiment of the invention, a method to help, encourage, inspire, remind, reward, focus or otherwise inform a user is now described with reference to flowchart 10 of FIG. 1. The method begins at Block 12 and includes positioning a user selected memento or a memento selected by a third party to have special meaning to the user onto a portable personal item so the user can readily experience the memento without handling the memento at Block 14. The method also includes connecting the memento to the portable personal item with a fastener carried by a side of the memento where the connection does not penetrate the portable personal item at Block 16. The method ends at Block 18.

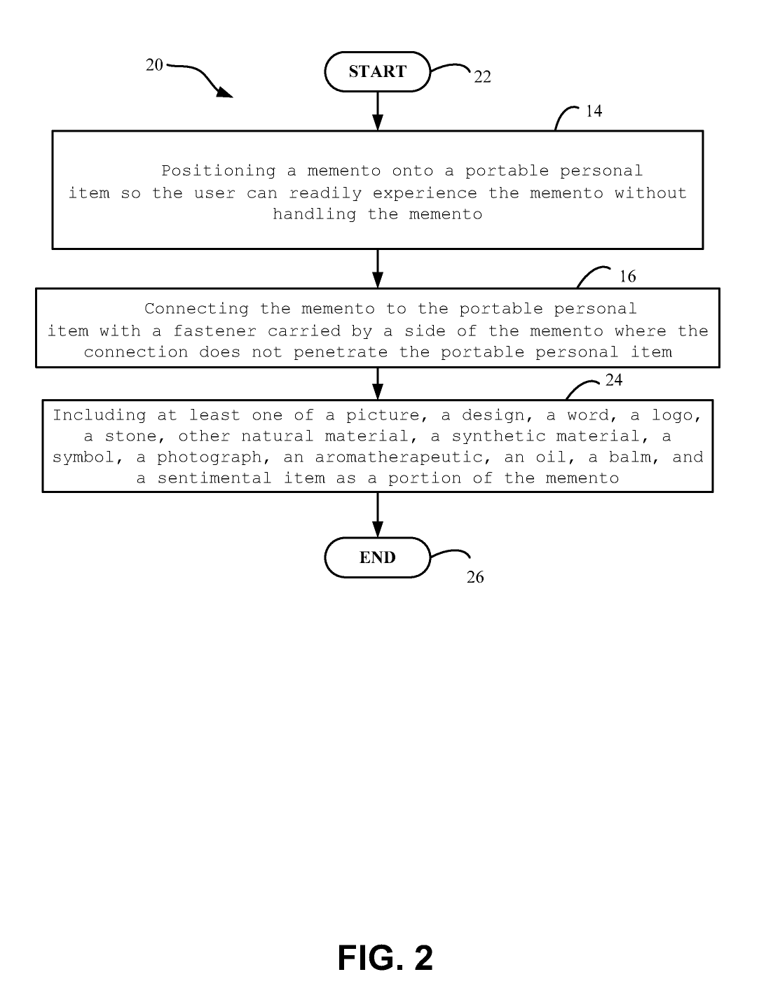

In another method embodiment, which is now described with reference to flowchart 20 of FIG. 2, the method begins at Block 22. The method may include the steps of FIG. 1 at Blocks 14 and 16. The method further comprises including a picture, a design, a word, a logo, a stone, other natural material, a synthetic material, a symbol, a photograph, an aromatherapeutic, an oil, a balm, and/or a sentimental item as a portion of the memento at Block 24. The method ends at Block 26.

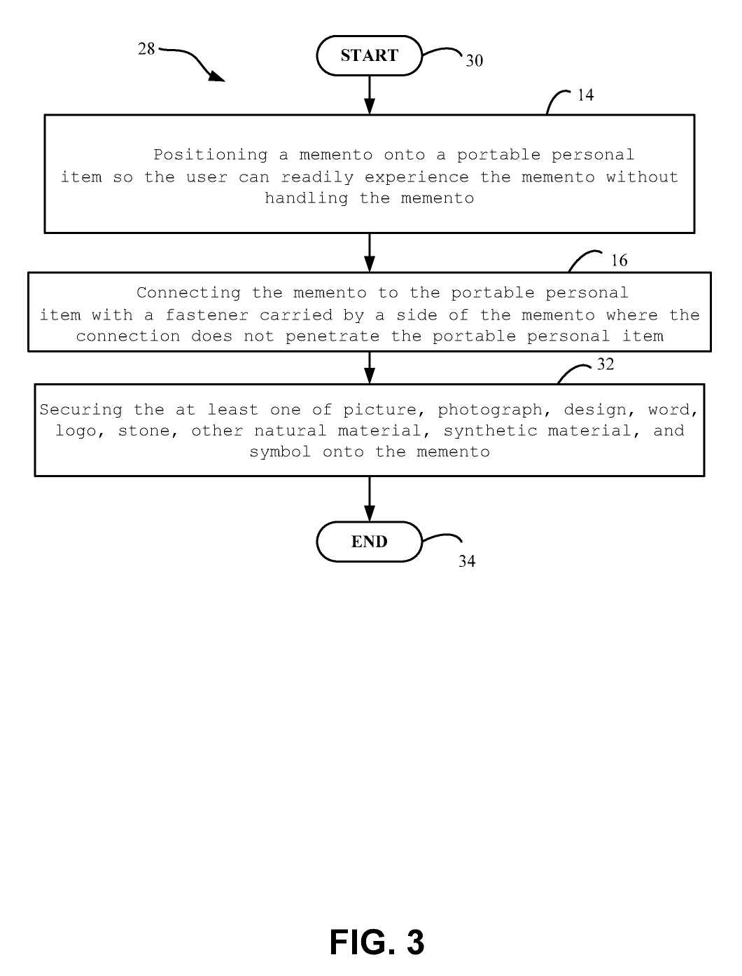

In another method embodiment, which is now described with reference to flowchart 28 of FIG. 3, the method begins at Block 30. The method may include the steps of FIG. 1 at Blocks 14 and 16. The method additionally includes securing the picture, photograph, design, word, logo, stone or other natural or synthetic material, and/or symbol onto the memento at Block 32. The method ends at Block 34. The securing comprises adhesion, welding, use of fasteners, and/or the like.

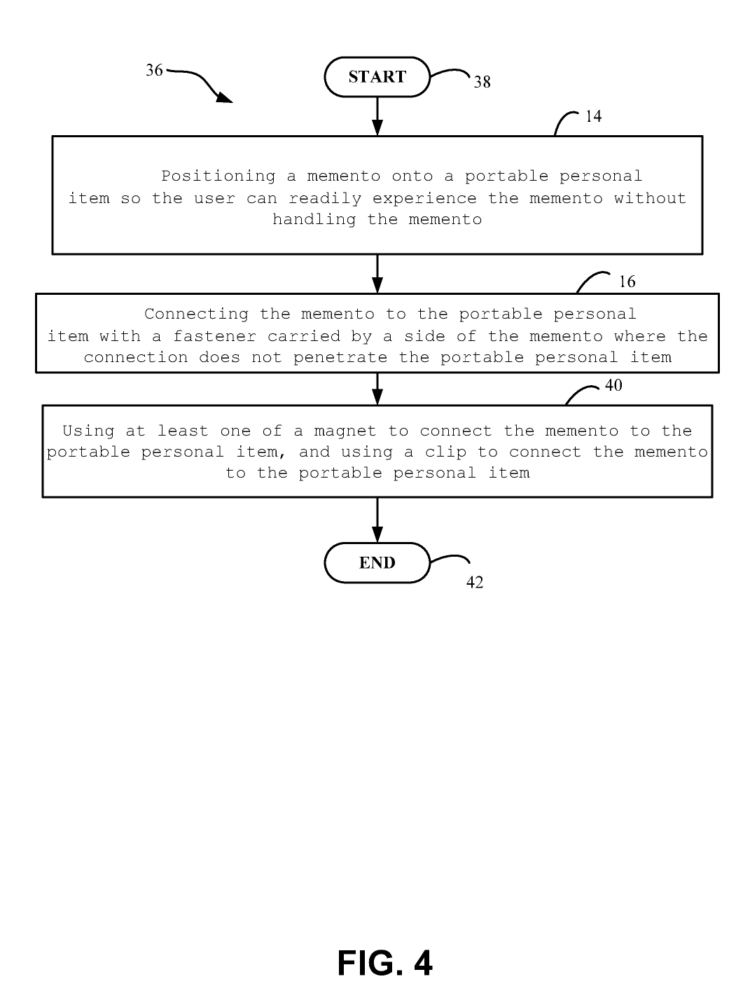

In another method embodiment, which is now described with reference to flowchart 36 of FIG. 4, the method begins at Block 38. The method may include the steps of FIG. 1 at Blocks 14 and 16. The method also includes using a magnet or magnets to connect the memento to the portable personal item and/or using a clip to connect the memento to the portable personal item and/or a pin and fastener to connect the memento to the personal item and/or an alternative method of fastening at Block 40. The method ends at Block 42. In another embodiment, the portable personal item includes a yoga mat, a towel, a blanket, a bag, a ribbon, a holder for such memento(s), and/or clothing.

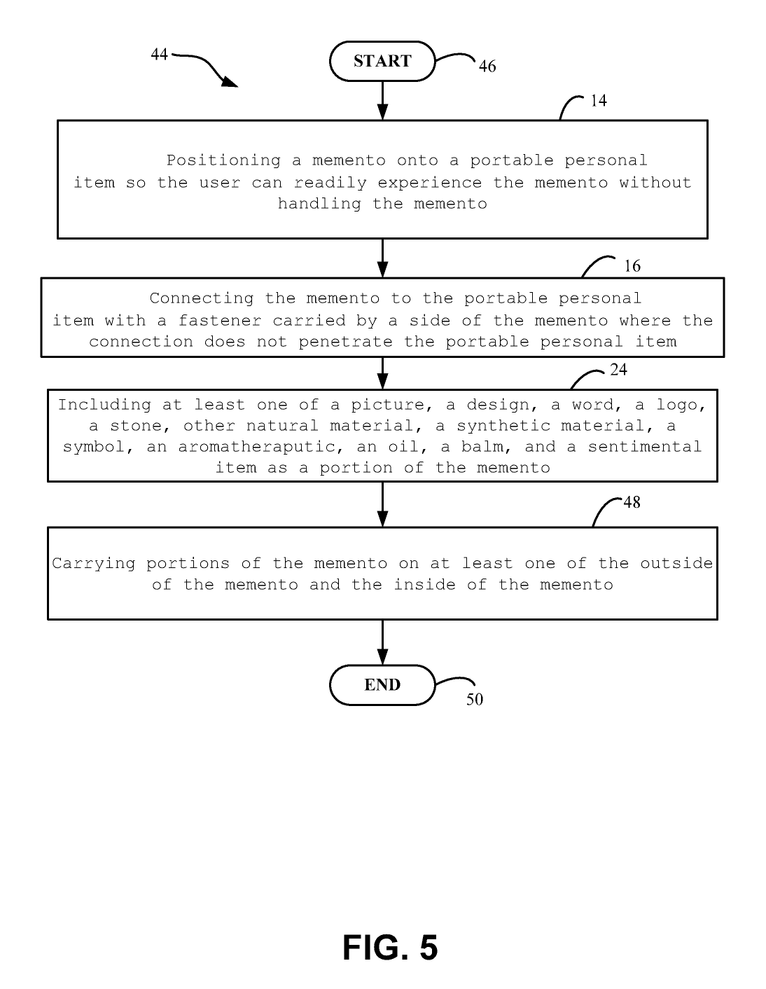

In another method embodiment, which is now described with reference to flowchart 44 of FIG. 5, the method begins at Block 46. The method may include the steps of FIG. 2 at Blocks 14, 16, and 24. The method further includes carrying portions of the memento on the outside of the memento and/or the inside of the memento at Block 48. The method ends at Block 50.

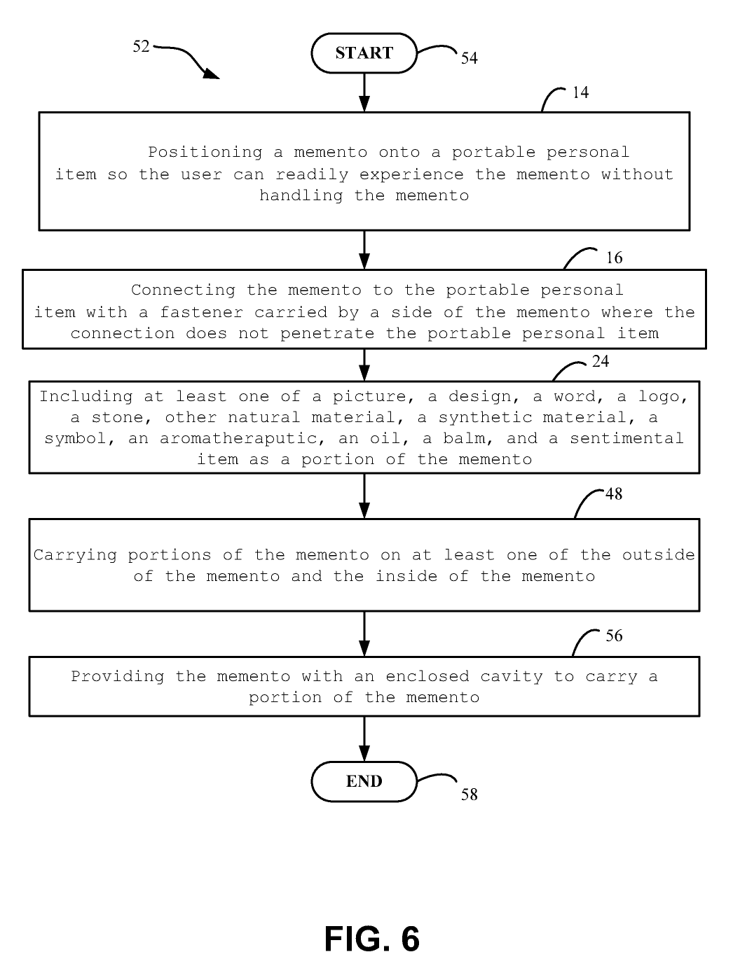

In another method embodiment, which is now described with reference to flowchart 52 of FIG. 6, the method begins at Block 54. The method may include the steps of FIG. 5 at Blocks 14, 16, 24, and 48. The method additionally includes providing the memento with an enclosed cavity to carry a portion of the memento at Block 56. The method ends at Block 58. In another embodiment, the enclosed cavity comprises at least one of a screw top, a hinge top, a slide top, and/or the like.

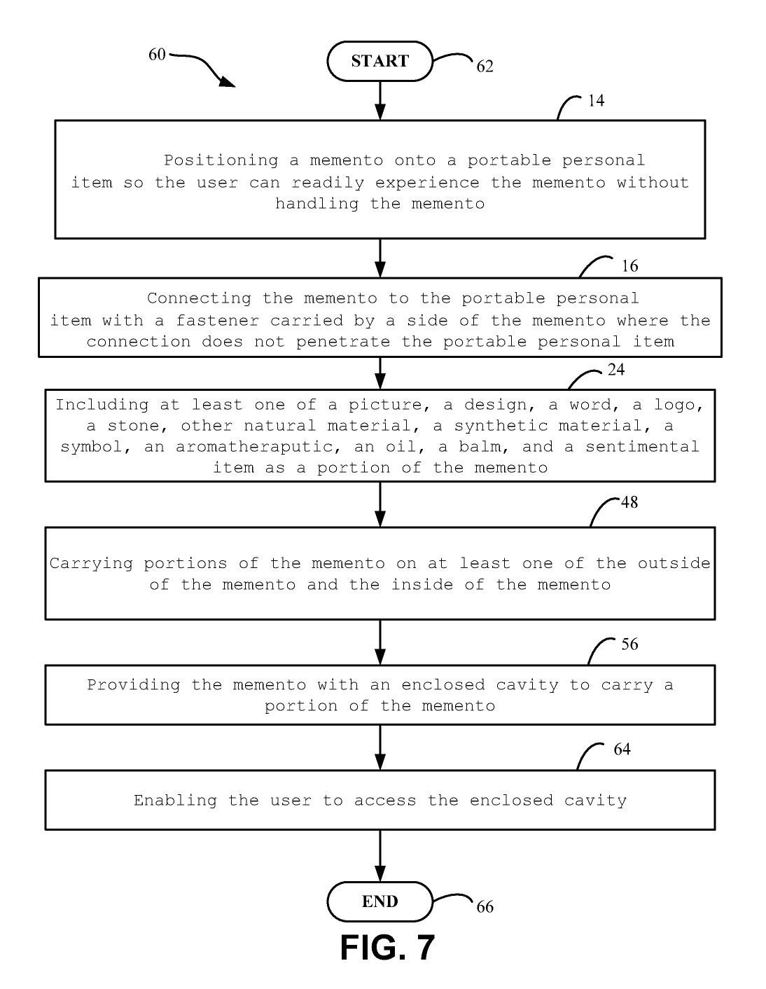

In another method embodiment, which is now described with reference to flowchart 60 of FIG. 7, the method begins at Block 62. The method may include the steps of FIG. 6 at Blocks 14, 16, 24, 48 and 56. The method also includes enabling the user to access the enclosed cavity. In another embodiment, the memento has a specific meaning to the user, which may be known or unknown to any person other than the user at Block 64. The method ends at Block 66.

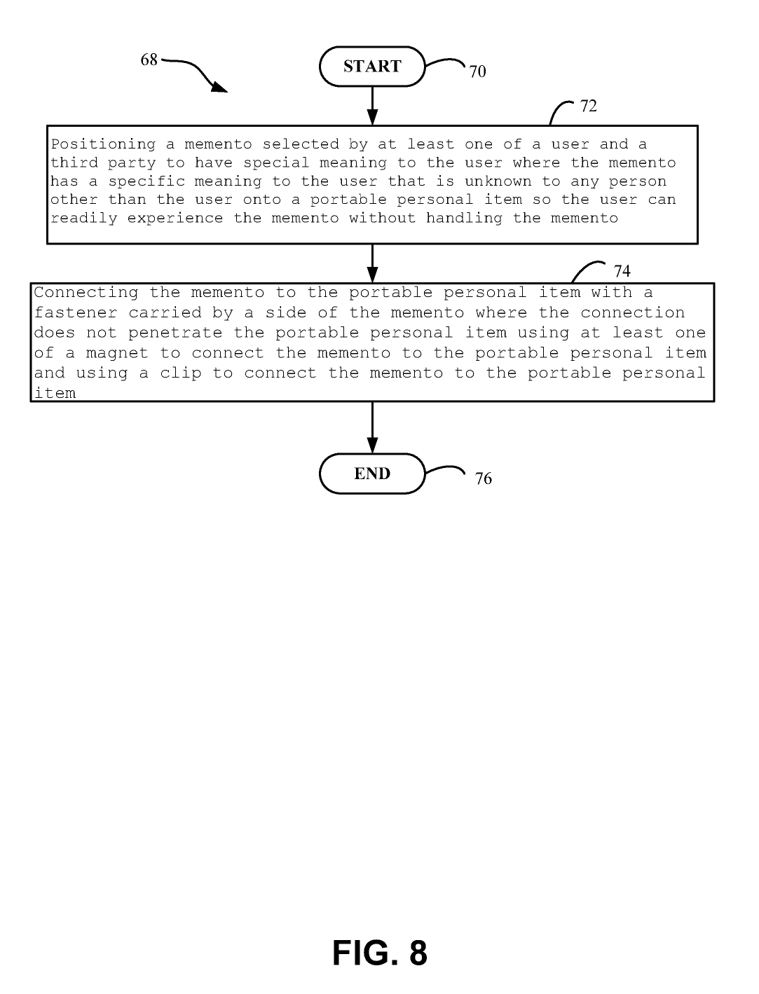

In another method embodiment, which is now described with reference to flowchart 68 of FIG. 8, the method begins at Block 70. The method helps, encourages, inspires, reminds, rewards, focuses or otherwise informs a user by positioning a user selected memento or a memento selected by a third party to have special meaning to a user where the memento has a specific meaning to the user that may be known or unknown to any person other than the user onto a portable personal item so the user can readily experience the memento without handling the memento at Block 72. The method also includes connecting the memento to the portable personal item with a fastener carried by a side of the memento where the connection does not penetrate the portable personal item using at least one of a magnet or magnets to connect the memento to the portable personal item and using a clip to connect the memento to the portable personal item and/or a pin and fastener to connect the memento to the personal item and/or an alternative method of fastening at Block 74. The method ends at Block 76.

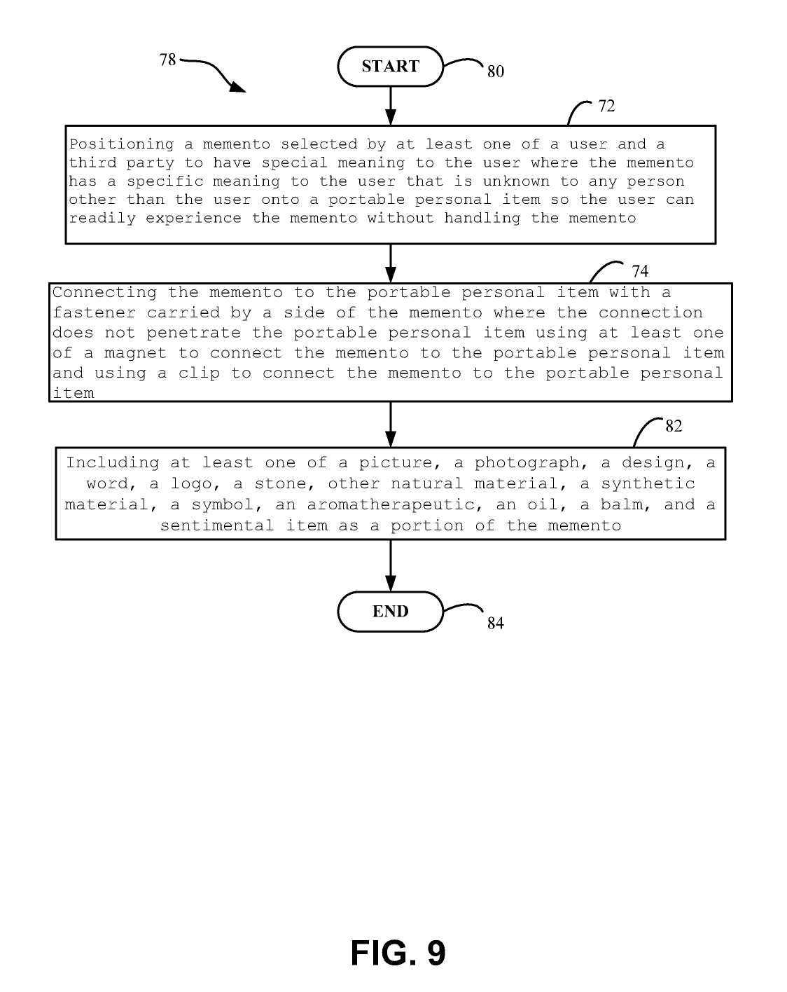

In another method embodiment, which is now described with reference to flowchart 78 of FIG. 9, the method begins at Block 80. The method may include the steps of FIG. 8 at Blocks 72 and 74. The method further comprises including a picture, a design, a word, a logo, a stone or other natural or synthetic material, a symbol, a photograph, an aromatherapeutic, an oil, a balm, and/or a sentimental item as a portion of the memento at Block 82. The method ends at Block 84.

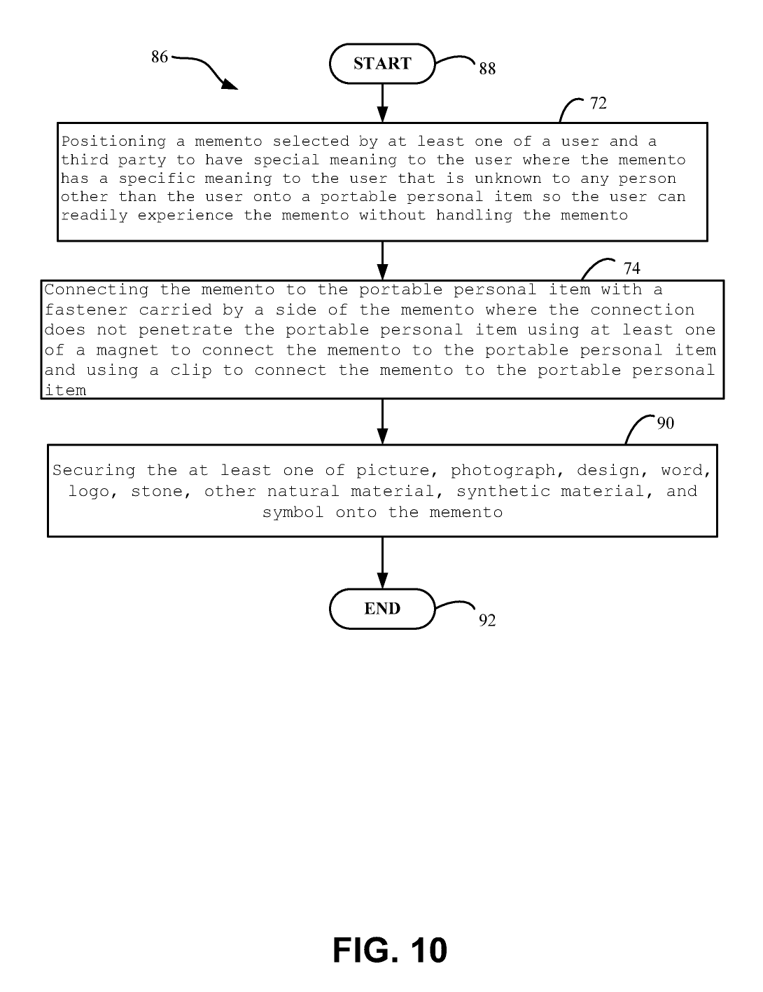

In another method embodiment, which is now described with reference to flowchart 86 of FIG. 10, the method begins at Block 88. The method may include the steps of FIG. 8 at Blocks 72 and 74. The method additionally includes securing the picture, photograph, design, word, logo, stone or other natural or synthetic material, and/or symbol onto the memento at Block 90. The method ends at Block 92.

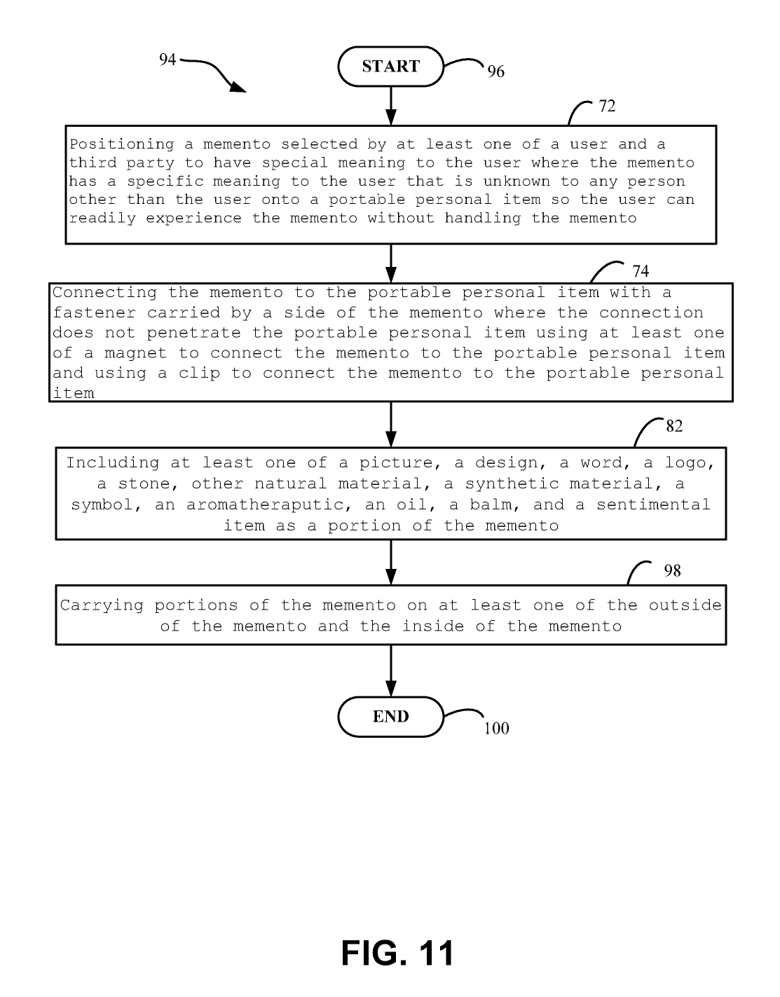

In one embodiment, the portable personal item includes a yoga mat, a towel, a blanket, a bag, a ribbon, a holder for such memento(s), and/or clothing. In another method embodiment, which is now described with reference to flowchart 94 of FIG. 11, the method begins at Block 96. The method may include the steps of FIG. 9 at Blocks 72, 74, and 82. The method also includes carrying portions of the memento on the outside of the memento and/or the inside of the memento at Block 98. The method ends at Block 100.

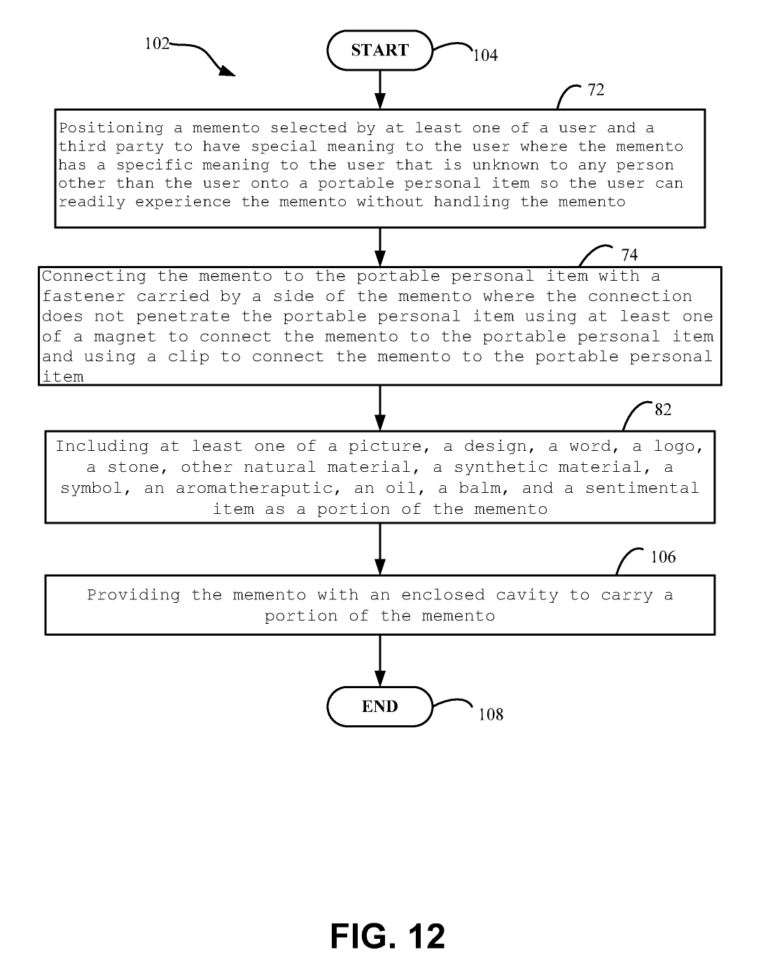

In another method embodiment, which is now described with reference to flowchart 102 of FIG. 12, the method begins at Block 104. The method may include the steps of FIG. 9 at Blocks 72, 74, and 82. The method further includes providing the memento with an enclosed cavity to carry a portion of the memento at Block 106. The method ends at Block 108.

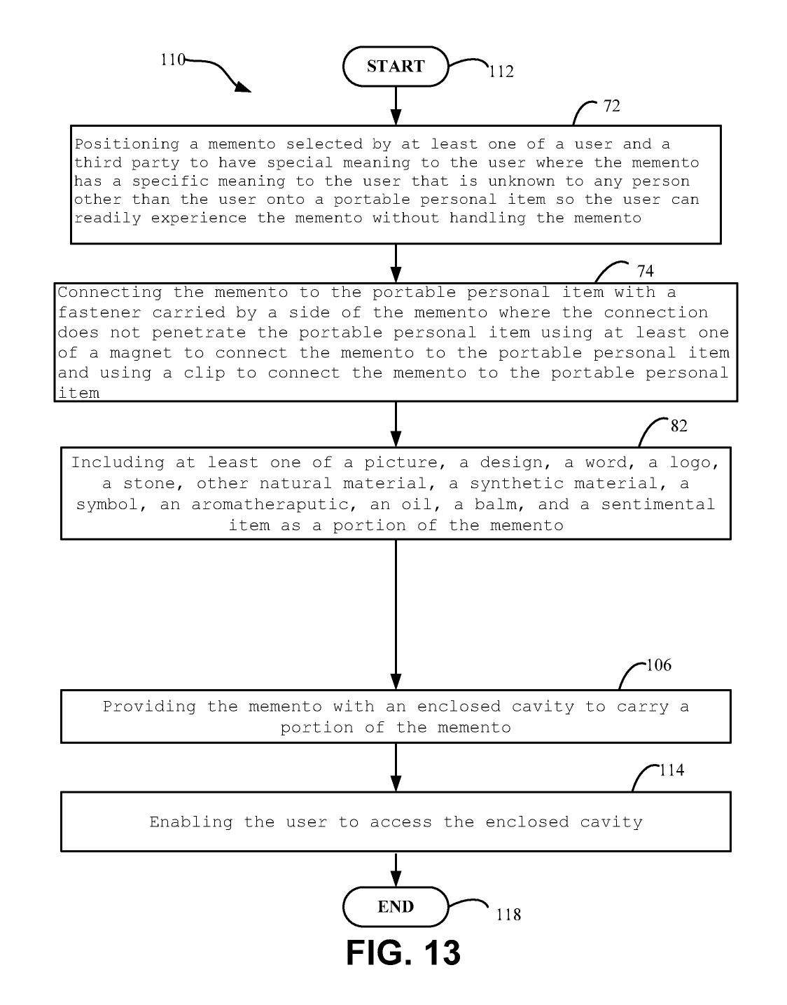

In another method embodiment, which is now described with reference to flowchart 110 of FIG. 13, the method begins at Block 112. The method may include the steps of FIG. 12 at Blocks 72, 74, 82 and 106. The method additionally includes enabling the user to access the enclosed cavity at Block 114. The method ends at Block 118.

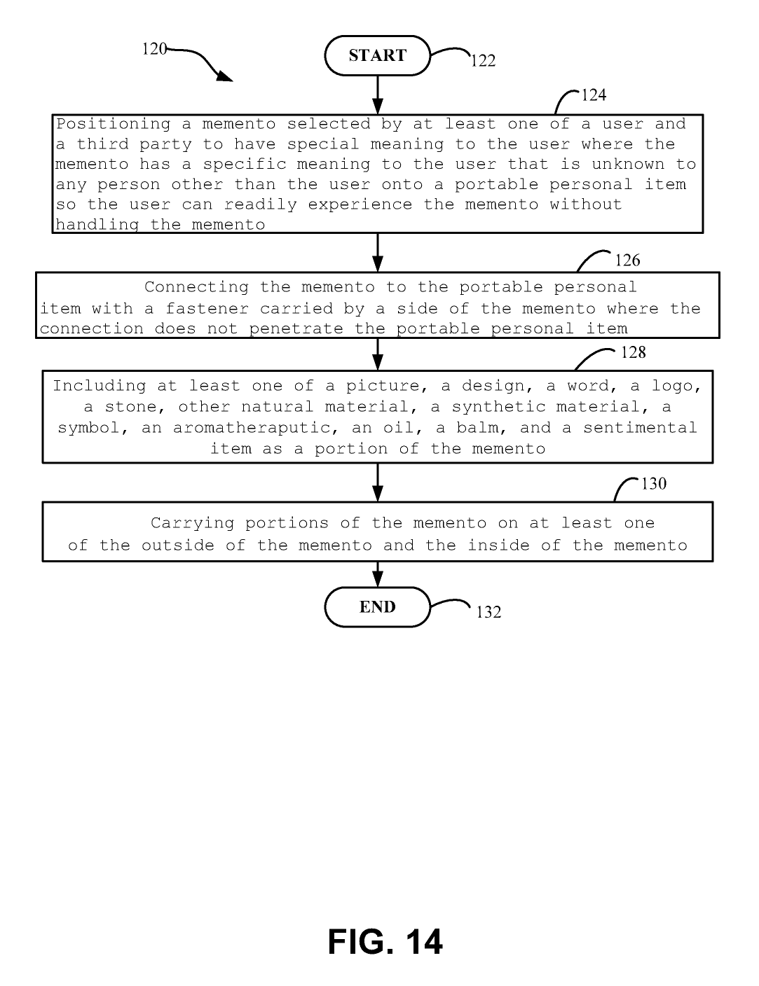

In another method embodiment, which is now described with reference to flowchart 120 of FIG. 14, the method begins at Block 122. The method helps, encourages, inspires, reminds, rewards, focuses or otherwise informs a user by positioning a user selected memento, or a memento selected by a third party to have special meaning to a user, where the memento has a specific meaning to the user that may be known or unknown to any person other than the user onto a portable personal item so the user can readily experience the memento without handling the memento at Block 124. The method also includes connecting the memento to the portable personal item with a fastener carried by a side of the memento where the connection does not penetrate the portable personal item at Block 126. The method further comprises including at least one of a picture, a design, a word, a logo, a stone, other natural material, a synthetic material, a symbol, a photograph, an aromatherapeutic, an oil, a balm, and/or a sentimental item as a portion of the memento at Block 128. The method additionally includes carrying portions of the memento on the outside of the memento and/or the inside of the memento at Block 130. The method ends at Block 132.

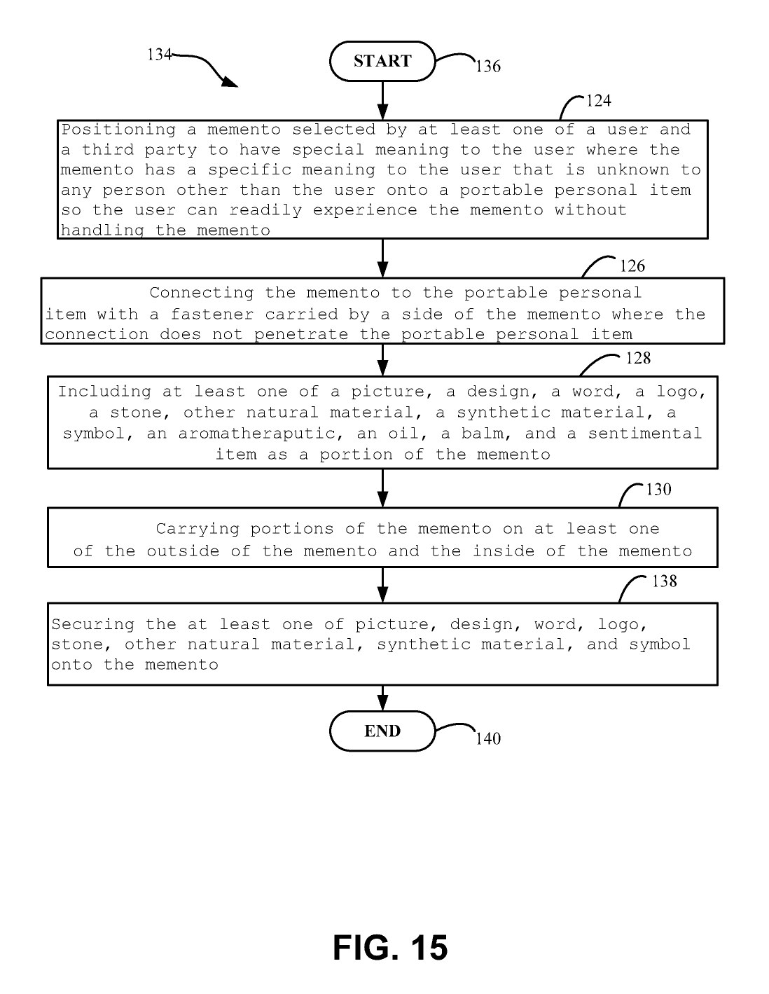

In another method embodiment, which is now described with reference to flowchart 134 of FIG. 15, the method begins at Block 136. The method may include the steps of FIG. 14 at Blocks 124, 126, 128, and 130. The method also includes securing the at least one of picture, photograph, design, word, logo, stone, other natural material, a synthetic material, and/or symbol onto the memento at Block 138. The method ends at Block 140.

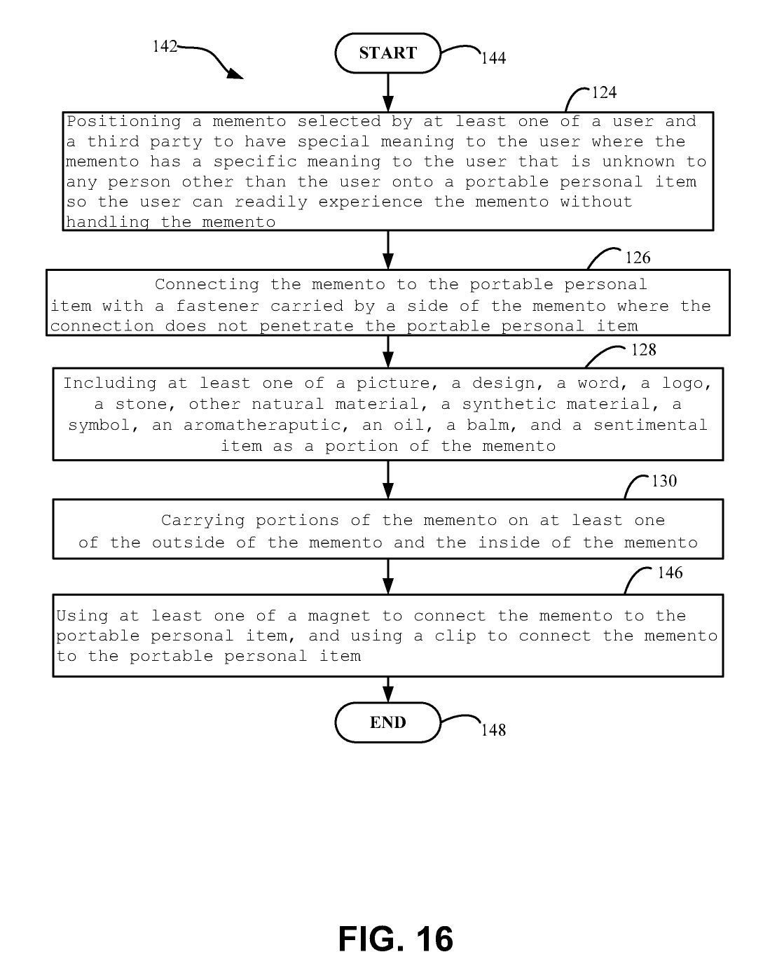

In another method embodiment, which is now described with reference to flowchart 142 of FIG. 16, the method begins at Block 144. The method may include the steps of FIG. 14 at Blocks 124, 126, 128, and 130. The method further includes using a magnet or magnets to connect the memento to the portable personal item and/or using a clip to connect the memento to the portable personal item and/or a pin and fastener to connect the memento to the personal item and/or an alternative method of fastening at Block 146. The method ends at Block 148.

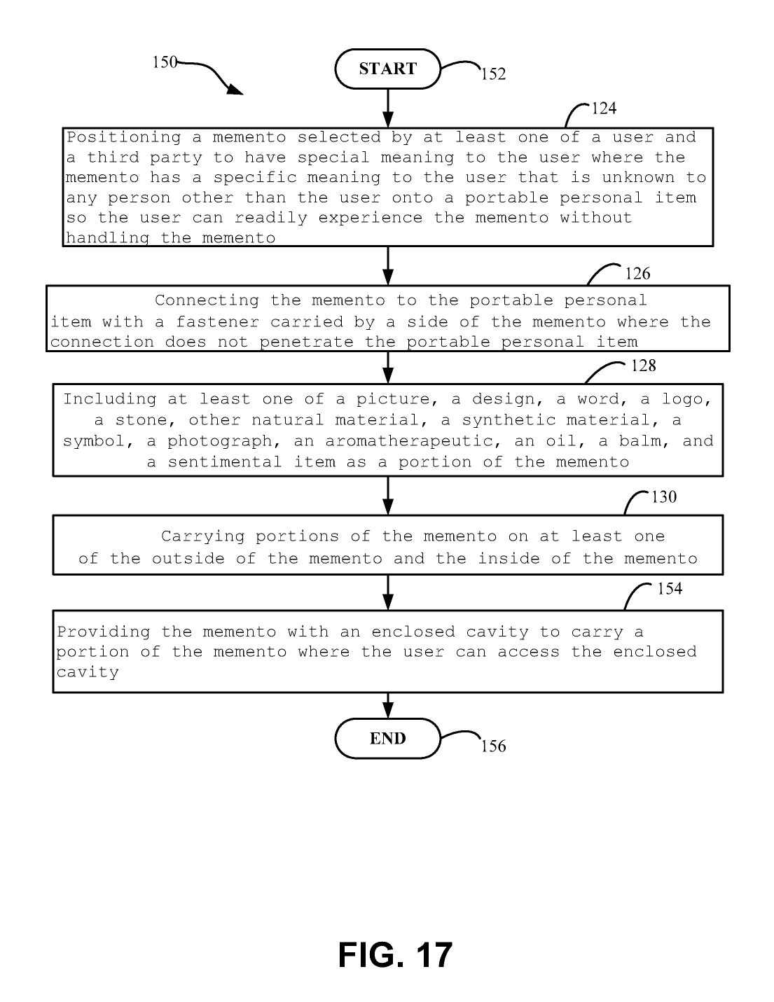

In another method embodiment, which is now described with reference to flowchart 150 of FIG. 17, the method begins at Block 152. The method may include the steps of FIG. 14 at Blocks 124, 126, 128, and 130. The method additionally includes providing the memento with an enclosed cavity to carry a portion of the memento where the user can access the enclosed cavity at Block 154. The method ends at Block 156.

In view of the foregoing, the claimed methods help, encourage, inspire, remind, reward, focus or otherwise inform a user because the positioning of the memento enables the user to experience the memento. Mementos or other objects comprising souvenirs, keepsakes, tokens or other reminders can be used by users to represent experiences, goals, rewards, achievements, objectives, observations, aspirations, and the like. User selected mementos, or mementos selected by a third party to have special meaning to a user, can be made further meaningful based on the sentiments of the user when selecting the memento him or herself, or receiving the memento from a third party. Such memento can then be experienced by the user in a way that helps, encourages, inspires, reminds, rewards, focuses or otherwise informs the user of that meaning.

In this case, where such memento is attached to a personal item of the user, that user may experience the memento without having to handle the memento, and receive the benefits of the sentiment as part of a larger experience such as during yoga, exercise, resting, meditating, or during the normal course of a daily routine. Additionally, a compliment or combination of the mementos may further enhance the experience of the user by representing multiple meanings.

The memento acts as a focal point for the user to experience a particular sentiment. The memento is experienced by the user to focus them on a particular sentiment personal to the user.

Unlike a name badge, tag, or decorative accessory where the objective is outward communication, representation of information, or personal image, the memento represents a point of focus for the user that the user experiences internally. This internal point of focus is experienced in a way that helps, encourages, inspires, reminds, rewards, focuses or otherwise informs the user of a particular meaning or meanings.

Further, unlike name badges, tags, or decorative accessories whose purpose is external, outward communication or expression, the purpose of these mementos is to facilitate internal expression by focusing the mind and experiencing the meaning that the memento represents. The mementos are not about outward image, but about internal meaning and sentiment which the user utilizes as a focal point to enhance a particular experience.

As will be appreciated by one skilled in the art, the invention may be embodied as a method and/or system. It should be noted that in some alternative implementations, the functions noted in a flowchart block may occur out of the order noted in the figures. For instance, two blocks shown in succession may, in fact, be executed substantially concurrently, or the blocks may sometimes be executed in the reverse order, depending upon the functionality involved because the flow diagrams depicted herein are just examples. There may be many variations to these diagrams or the steps (or operations) described therein without departing from the spirit of the invention. For example, the steps may be performed concurrently and/or in a different order, or steps may be added, deleted, and/or modified. All of these variations are considered a part of the claimed invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method comprising:
positioning a memento onto a portable personal item so the user can readily experience the memento without handling the memento; and
connecting the memento to the portable personal item with a fastener carried by a side of the memento where the connection does not penetrate the portable personal item.

2. The method of claim 1 further comprising including at least one of a picture, a design, a word, a logo, a stone, other natural material, a synthetic material, a symbol, a photograph, an aromatherapeutic, an oil, a balm, and a sentimental item as a portion of the memento.

3. The method of claim 1 further comprising securing the at least one of picture, photograph, design, word, logo, stone, other natural material, synthetic material, and symbol onto the memento.

4. The method of claim 1 further comprising using at least one of a magnet to connect the memento to the portable personal item, and using a clip to connect the memento to the portable personal item.

5. The method of claim 1 wherein the portable personal item comprises at least one of a yoga mat, a towel, a carrying case for the memento, a blanket, a bag, a ribbon, and clothing.

6. The method of claim 2 further comprising carrying portions of the memento on at least one of the outside of the memento and the inside of the memento.

7. The method of claim 6 further comprising providing the memento with an enclosed cavity to carry a portion of the memento.

8. The method of claim 7 further comprising enabling the user to access the enclosed cavity.

9. The method of claim 1 wherein the memento has a specific meaning to the user, which is unknown to any person other than the user.

10. A method comprising:
positioning a memento selected by at least one of a user and a third party to have special meaning to the user where the memento has a specific meaning to the user that is unknown to any person other than the user onto a portable personal item so the user can readily experience the memento without handling the memento; and
connecting the memento to the portable personal item with a fastener carried by a side of the memento where the connection does not penetrate the portable personal item using at least one of a magnet to connect the memento to the portable personal item and using a clip to connect the memento to the portable personal item.

11. The method of claim 10 further comprising including at least one of a picture, a design, a word, a logo, a stone, other natural material, a synthetic material, a symbol, a photograph, an aromatherapeutic, an oil, a balm, and a sentimental item as a portion of the memento.

12. The method of claim 10 further comprising securing the at least one of picture, photograph, design, word, logo, stone, other natural material, synthetic material, and symbol onto the memento.

13. The method of claim 10 wherein the portable personal item comprises at least one of a yoga mat, a towel, a carrying case for the memento, a blanket, a bag, a ribbon, and clothing.

14. The method of claim 11 further comprising carrying portions of the memento on at least one of the outside of the memento and the inside of the memento.

15. The method of claim 11 further comprising providing the memento with an enclosed cavity to carry a portion of the memento.

16. The method of claim 15 further comprising enabling the user to access the enclosed cavity.

17. A method comprising:
positioning a memento selected by at least one of a user and a third party to have special meaning to the user where the memento has a specific meaning to the user that is unknown to any person other than the user onto a portable personal item so the user can readily experience the memento without handling the memento;
connecting the memento to the portable personal item with a fastener carried by a side of the memento where the connection does not penetrate the portable personal item;
including at least one of a picture, a design, a word, a logo, a stone, other natural material, a synthetic material, a symbol, a photograph, an aromatherapeutic, an oil, a balm, and a sentimental item as a portion of the memento; and
carrying portions of the memento on at least one of the outside of the memento and the inside of the memento.

18. The method of claim 17 further comprising securing the at least one of picture, photograph, design, word, logo, stone, other natural material, synthetic material, and symbol onto the memento.

19. The method of claim 17 further comprising using at least one of a magnet to connect the memento to the portable personal item, and using a clip to connect the memento to the portable personal item.

20. The method of claim 17 further comprising providing the memento with an enclosed cavity to carry a portion of the memento where the user can access the enclosed cavity.
